(19) United States
(12) Patent Application Publication
(10) Pub. No.: US 2024/0307993 A1
(43) Pub. Date: Sep. 19, 2024

(54) WELDING OF ELECTRIC VEHICLE BATTERIES

(71) Applicant: AQUASIUM TECHNOLOGY LIMITED, Cambridgeshire (GB)

(72) Inventors: Alex O'FARRELL, Cambridge (GB); Paul PLUMB, Cambridge (GB); Conrad DUMONT, Cambridge (GB)

(21) Appl. No.: 18/576,772

(22) PCT Filed: May 20, 2022
(86) PCT No.: PCT/GB2022/051283

§ 371 Date: Jan. 5, 2024

(30) Foreign Application Priority Data
Jul. 5, 2021 (GB) 2109668.0

(51) Int. Cl. B23K 15/06; B23K 15/02; H01M 50/213; H01M 50/516

(52) U.S. Cl. CPC B23K 15/06; B23K 15/02; H01M 50/213; H01M 50/516; H01M 2220/20

(57) ABSTRACT

There is provided electron beam welding apparatus comprising an electron beam gun (50) associated with a welding chamber (54) configured for welding of a battery array (33) to a bus bar (32) and beam adjustment devices (56, 58) operative in response to a controller (60) to modify beam characteristics and position of an electron beam (52) generated by the electron beam gun (50), wherein at least two subsidiary chambers (70, 72) are disposed on opposing sides of the welding chamber (54), all chambers being evacuable to be under a vacuum, and a beam detector (61) is positioned proximal the welding chamber (54) to generate data relating to beam characteristics and position, the controller (60) configured to respond to data from the beam detector (61) to control synchronously the beam adjustment devices (56, 58) and to create a consistent welding penetration depth for welds formed between a bus bar (32) and a battery array (33) regardless of angle of incidence of an electron beam. An associated welding method is also provided.

### FIELD OF THE INVENTION

This invention relates to welding of electric vehicle batteries, in particular electron beam welding of batteries comprising cylindrical cells.

### BACKGROUND TO THE INVENTION

Electric vehicle production is scaling up worldwide but a bottle neck in the production of these vehicles is the rate of battery production. The batteries require good electrical connections of low electrical resistance to maximise electrical efficiency, so welding of the connectors is required. The welds often require joining dissimilar metals and always require minimal heat input in to the battery to prevent damage, as some of the battery materials are highly flammable.

Welding of connectors to such vehicle batteries usually takes place using a laser. The laser is deflected from a single point source to weld an array of battery cells to connectors. Mechanical manipulation of a prism is used to alter beam direction but this limits the welding rate. Long focal ranges and large deflection angles reduce accuracy of the weld and also introduce stigmatism in the laser beam that creates variation in the weld quality across the battery.

Given many electrical components associated with the battery are made of aluminium or aluminium alloys that oxidise during the welding, laser welding needs to be performed under expensive shielding gases such as Argon. Laser welding is also unable to weld certain metals due to reflectivity issues which limits the metals that can be used in battery production.

### SUMMARY OF THE INVENTION

In accordance with one aspect of the invention there is provided electron beam welding apparatus comprising an electron beam gun associated with a welding chamber configured for welding of a battery array to a bus bar and beam adjustment devices operative in response to a controller modify beam characteristics and position of an electron beam generated by the electron beam gun, wherein at least two subsidiary chambers are disposed on opposing sides of the welding chamber, all chambers being evacuable to be under a vacuum, and a beam detector is positioned proximal the welding chamber to generate data relating to beam characteristics and position, the controller configured to respond to data from the beam detector to control synchronously the beam adjustment devices and to create a consistent welding penetration depth for welds formed between a bus bar and a battery array regardless of angle of incidence of an electron beam. Thus welding depth can be controlled, avoiding excess penetration into the cell which can result in combustion. Welding within vacuum also ensures that any combustion taking place would be minimised.

The beam adjustment devices are typically electromagnetic coils arranged to achieve high speed deflection, dynamic focus and dynamic stigmatism control of the electron beam.

Preferably the welding chamber is separable from each subsidiary chamber by a sealable door to allow independent evacuation of each chamber. This may desirably be achieved by the sealable door being a foldable door, pivotably moveable from an aperture between adjacent chambers to a side wall of a subsidiary chamber.

In accordance with another aspect of the present invention, there is provided electron beam welding apparatus comprising an electron beam gun associated with a welding chamber configured for welding a battery array to a bus bar, beam adjustment devices operative in response to a controller to modify beam characteristics and position of an electron beam generated by the electron beam gun, wherein at least two subsidiary chambers are disposed on opposing sides of the welding chamber, all chambers being evacuable to be under a vacuum, wherein the welding chamber is separable from each subsidiary chamber by sealable doors to allow independent evacuation of each of the welding chamber and subsidiary chambers, at least one of the sealable doors being a foldable door, pivotably moveable from an aperture between the welding chamber and a subsidiary chamber to a side wall of the subsidiary chamber.

For both aspects of the present invention, the apparatus may further comprise conveying means associated with the chambers for transport of a battery array and a bus bar between the chambers. This allows for automation of throughflow of bus bars and battery arrays through the welding chamber.

The conveying means may comprise a conveyor means comprising three substantially adjoining sections, one section disposed in each chamber and may further or alternatively comprise a pushing element.

The apparatus may further comprise a linear succession of a plurality of subsidiary chambers so as to ensure that a good vacuum can be maintained in the welding chamber even upon entry of a bus bar and a battery array into the welding chamber.

In accordance with a third aspect of the invention, there is provided a method of electron beam welding vehicle batteries comprising:
(i) placing a battery array and a bus bar into a welding chamber of an electron beam gun;
(ii) positioning a beam detector proximal the battery array and bus bar;
(iii) generating an electron beam to weld the battery array to the bus bar at a plurality of positions;
(iii) sending data from the beam detector to a controller to control synchronously beam adjustment devices in response to the data so as to create a consistent welding penetration depth for welds formed between the bus bar and the battery array regardless of angle of incidence of an electron beam.

The method may further comprise creating a plurality of linear welds between the bus bar and the battery array. This provides a greater contact surface area and a more robust weld than spot welds.

The battery array and the bus bar are preferably placed in a preliminary chamber before entering the welding chamber, the preliminary chamber and the welding chamber being evacuated before the array is moved under vacuum into the welding chamber.

The battery array and the bus bar may be conveyed between the chambers using a conveyor means comprising three substantially adjoining sections, one section disposed in each chamber.

Desirably the battery array is an array of cylindrical cells.

The invention will now be described by way of example with reference to the following drawings in which:

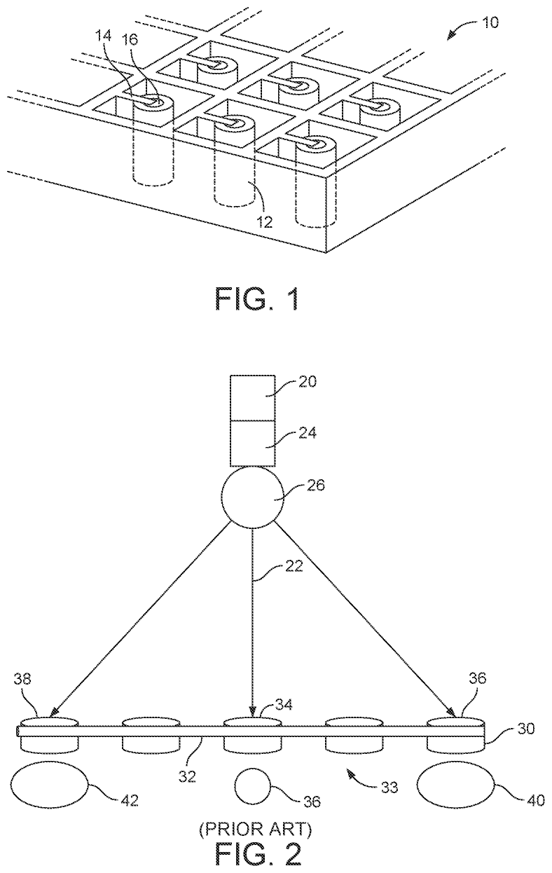

FIG. 1 is a view of part of a vehicle battery;

FIG. 2 is a schematic diagram of prior art laser welding;

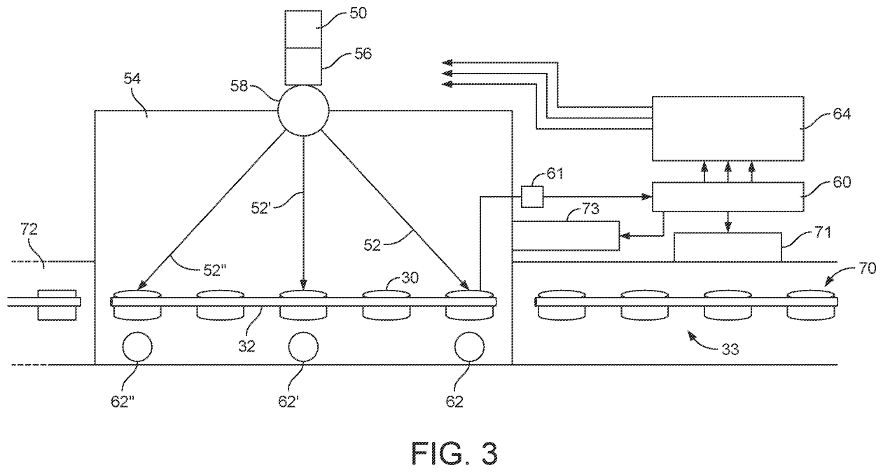

FIG. 3 is a schematic diagram of electron beam welding of a vehicle battery in accordance with the invention; and

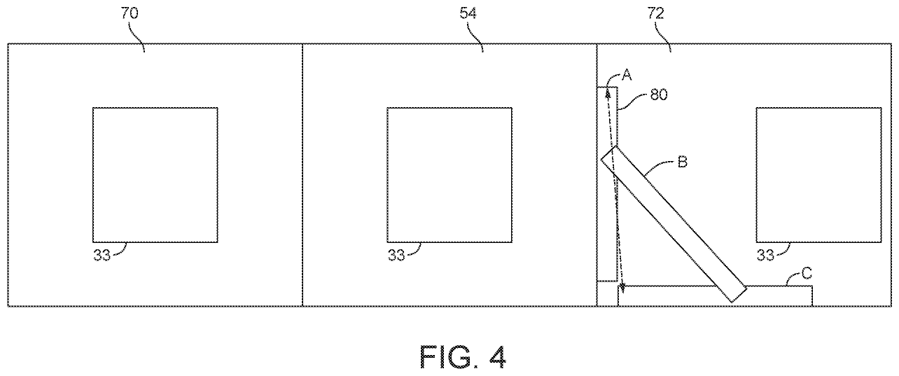

FIG. 4 is a schematic diagram of a loading chamber arrangement.

### DESCRIPTION

FIG. 1 shows an electric storage device or battery 10 typically used in electric-powered vehicles, battery 10 being of the cylindrical type and comprising an array of individual power cells 12, for example Lithium-ion cells or Nickel-hydride cells. Each battery 10 is typically made up of hundreds of cylindrical cells 12 arranged in a grid array. Battery bus bars 14 are used to connect individual cells 12 within the array to each other. Bars 14 are generally welded to a top face of each cell 12 using laser welding, with a laser deflected to a weld position at the top of each cell 12 using a prism so as to weld a connecting tab 16 associated with each cell 12 to bus bar 14 using an 8 mm circular weld. Bus bar 14 has further welds comprising rows of spot welds to create connections into cells 12.

A schematic diagram to illustrate prior art laser welding is shown in FIG. 2. Laser 20 generates a laser beam 22 which is focused using lens 24 and deflected using motorised deflection prism 26 to different weld positions associated with an array of cells 30 requiring welding to bus bar 32. Typically battery cell array 33 is laid out over an area around 500 mm×500 mm. When a weld region 34 is directly below laser 20, then the laser beam diameter 36 is circular. Where beam 22 impinges a weld region 36, 38 at an angle, then the cross section 40, 42 of the beam is distorted and shows stigmatism and becomes ovoid in cross section rather than circular.

The mechanical manipulation of laser prism 26 to deflect beam 22 limits the maximum possible welding rate and long focal ranges and large deflection angles impair accuracy and introduce stigmatism in the laser beam and so create variation in the weld quality across array 33. Reflectivity of beam 22 prevents certain metals being welded using this method. For aluminium or aluminium alloys that oxidise during welding, welding must be performed under expensive shielding gases such as Argon.

Using electron beam (EB) welding instead of laser beam welding overcomes many of the issues associated with laser beam welding of bus bars in relation to cylindrical batteries comprising an array of cylindrical cells. FIG. 3 shows an EB welding set-up for welding bus bars and other connectors to an array 33 of battery cells. Electron gun 50 generates an electron beam 52, three separate positions of which are shown, in vacuum chamber 54 with this beam deflected at high speed to achieve welding using dynamic focus and stigmator coils 56 and deflection coils 58 responsive to controller 60 to adjust the position and characteristics such as beam width and power/penetration for beam 52.

Array 33 of cells 30 requiring welding to bus bar 32 is disposed within main vacuum chamber 54 connected to gun 50. During operation a beam probe 61, such as a pin hole probe, detects profile 62 of beam 52 and instantaneously sends feedback data to controller 60 which adjusts power source 64 to alter power to coils 56, 58 so as to adjust the beam profile almost instantaneously. This synchronous control of beam generated in response to beam detected ensures a consistent circular cross-section beam profile regardless of incident angle of beam 52 onto a weld region as shown by way of example at three positions 52, 52′, 52″ and corresponding profiles 62, 62′ and 62″ which remain circular regardless of the angle of incidence of beam 52 onto bar 32.

As there are no physical moving parts in this deflection system and the electrons are of negligibly low mass, the only limiting factor on the speed of deflection is the inductance of the deflection coils 58. A deflection coil winding and power amplifier configuration can achieve deflection speeds is in excess of 15 times that achievable by the current laser prism system.

High speed deflection of beam 52, dynamic focus and dynamic stigmator coils are controlled synchronously. Refocusing is easily performed at high speed by a rapidly adjustable dynamic focusing coil 56 adjusting the convergence angle synchronously with the deflection control of coils 58, maintaining a constant weld spot diameter as the deflection system creates a change in working distance. To overcome the issue of stigmatism created by the deflected electron beam landing onto a surface that is not perpendicular to its direction of travel, stigmator coil assembly 56 can also be controlled synchronously to keep the beam shape the same at the point of welding by reshaping the beam in the column inversely so that it will be correct when landing on the surface. Beam probe 61 and associated controller 60 can be used to calibrate the focusing and stigmatism correction at each welding point.

Instead of circular spot welds, the EB beam apparatus comprising gun 50, coils 56, 58 and associated controller 60 is configurable to generate elongate linear welds so as to improve the robustness of the welded connection between bus bar 32 and each cell. In particular linear welds of length greater than twice the diameter of the circular cross-section beam are generated to weld each tab 16 to bus bar 14. Thus a linear weld to a constant penetration depth is created and if desired a weld length of greater than 10 mm, and typically a length in the range 10 to 20 mm, can be generated. Creating a linear weld provides a greater contact area between tab 16 and bus bar 14, improving connectivity and also improving robustness of the weld, as spot welds are more susceptible to failure over time or to failure in response to excessive vibration. Desirably the EB apparatus is arranged to use linear welds instead of spot welds, such that no spot welds are used to connect the array to the bus bar.

EB welding allows depth of penetration to be precisely controlled due to the feedback from the beam probe which reduces the risk of penetration into the cell itself which can cause fires. Should penetration into the cell occur during welding then the vacuum within chamber 54 acts to suppress any combustion without the need for shielding gas as required for laser welding. Welding in vacuum reduces weld porosity, so the final weld quality will be superior to that of a laser weld.

EB welding is capable of welding dissimilar metals without any problems with reflectivity as encountered with laser welding. As such car manufacturers will not be limited in their material choice due to the welding process and due to the absence of reflectivity and improved control of beam size and power will get a more uniform weld across each cell.

Loading vacuum chambers 70, 72 are disposed at opposite sides of chamber 54. This allows for rapid throughput of arrays into chamber 54. Thus welding will take place within chamber 54 as another array is loaded into preliminary chamber 70. Preliminary chamber 70 is then rapidly pumped down to a suitable vacuum level for welding using pumps and valves 71 and once welding is concluded in main welding chamber 54, the next array is ready to enter under vacuum whilst the just welded array exits the main chamber 54 to pass into secondary chamber 72 which is also under vacuum. Welding then begins again in chamber 54, with the next array entering preliminary chamber 70 for pumping down to a vacuum whilst secondary chamber 72 is vented back to atmosphere for removal of the welded array, and then once empty rapidly pumped to vacuum again ready for receiving the next welded array from chamber 54. Typically a baffle system is provided between the chambers to allow selective entry or exit of the next array. Pumps and valves 73 act to maintain a vacuum in chamber 54 with a similar set of valves and pumps for achieving a vacuum in secondary chamber 72.

Such a load lock system of chambers with an arrangement of sealable doors and movable tooling to pass arrays between the chambers ensures the central main welding chamber 54 is kept at a suitable vacuum whilst unload/loading chambers 70, 72 are ventilated. FIG. 3 depicts a linear arrangement with three chambers for loading, welding, and unloading using a push system to move the array between two chambers at a time with seals and sliding doors to separate whichever chamber is venting or pumping at a given time. Typically it will take around 4 seconds to weld a 13×13 array of cells and as such speed of throughput from the preliminary and secondary chambers is required to ensure the most productive throughput. To further improve the speed of throughput and reduce pump-down time of the system, further chambers could be added to the conveyor line to ensure that the vacuum in main chamber 54 stays almost constant.

A folding chamber interface door can be used instead of a sliding door, see FIG. 4 where chambers 54, 70 and 72 are viewed from above. Door 80 is moveable along an internal rail to move between a closed position A sealing off an aperture between chambers 54 and 72, to pivotally move through intermediate position B to reach position C against a side wall to allow free movement of arrays between the chambers.

Table 1 show a comparison of welding speeds between EB and laser with EB achieving a weld time of 4.3 s for an array of 13×13 batteries as compared with a time of 71 seconds for laser welding. Weld times are for a circular weld of 8 mm so as to compare like with like.

TABLE 1
Comparison of weld speeds for Laser with 3D scanner and
Electron Beam welding with fast deflection and focus

| | | EB with fast |
|---|---|---|
| | Laser with 3D scanner | deflection and focus |
| Jumping speed & time | (50 rads/sec) 25 m/sec at | (6000 rads/sec) 3000 |
| for 23 mm jump | 500 mm wd = 1 msec/ | m/sec at 500 mm wd = |
| | jump | 8 usec/jump |
| Welding speed & time | 120 mm/sec = 209 msec/ | 2 m/sec = 12.6 msec/ |
| for 8 mm circle | battery | battery |
| Time to weld 13 × 13 | 71 sec | 4.3 sec |
| batteries | | |

1. Electron beam welding apparatus comprising an electron beam gun associated with a welding chamber configured for welding of a battery array to a bus bar and beam adjustment devices operative in response to a controller to modify beam characteristics and position of an electron beam generated by the electron beam gun, wherein at least two subsidiary chambers are disposed on opposing sides of the welding chamber, all chambers being evacuable to be under a vacuum, and a beam detector is positioned proximal the welding chamber to generate data relating to beam characteristics and position, the controller configured to respond to data from the beam detector to control synchronously the beam adjustment devices and to create a consistent welding penetration depth for welds formed between a bus bar and a battery array regardless of angle of incidence of an electron beam.

2. Electron beam welding apparatus according to claim 1, wherein the welding chamber is separable from each subsidiary chamber by a sealable door to allow independent evacuation of each chamber.

3. Electron beam welding apparatus according to claim 2, wherein the sealable door is a foldable door, pivotably moveable from an aperture between the welding chamber and a subsidiary chamber to a side wall of the subsidiary chamber.

4. Electron beam welding apparatus comprising an electron beam gun associated with a welding chamber configured for welding a battery array to a bus bar, beam adjustment devices operative in response to a controller to modify beam characteristics and position of an electron beam generated by the electron beam gun, wherein at least two subsidiary chambers are disposed on opposing sides of the welding chamber, all chambers being evacuable to be under a vacuum, wherein the welding chamber is separable from each subsidiary chamber by sealable doors to allow independent evacuation of each of the welding chamber and subsidiary chambers, at least one of the sealable doors being a foldable door, pivotably moveable from an aperture between the welding chamber and a subsidiary chamber to a side wall of the subsidiary chamber.

5. Electron beam welding apparatus according to claim 4, further comprising conveying means associated with the chambers for transport of a battery array and a bus bar between the chambers.

6. Electron beam welding apparatus according to claim 5, wherein the conveying means comprises a conveyor means comprising three substantially adjoining sections, one section disposed in each chamber.

7. Electron beam welding apparatus according to claim 5, wherein the conveying means comprises a pushing element.

8. Electron beam welding apparatus according to claim 4, further comprising a linear succession of a plurality of subsidiary chambers.

9. A method of electron beam welding vehicle batteries comprising:
(i) placing a battery array and a bus bar into a welding chamber of an electron beam gun;
(ii) positioning a beam detector proximal the battery array and bus bar;
(iii) generating an electron beam to weld the battery array to the bus bar at a plurality of positions;
(iii) sending data from the beam detector to a controller to control synchronously beam adjustment devices in response to the data so as to create a consistent welding penetration depth for welds formed between the bus bar and the battery array regardless of angle of incidence of an electron beam.

10. A method of electron beam welding vehicle batteries according to claim 9, further comprising creating a plurality of linear welds between the bus bar and the battery array.

11. A method of electron beam welding vehicle batteries according to claim 9, further comprising placing the battery array and the bus bar in a preliminary chamber, and evacuating the preliminary chamber and the welding chamber before moving the array under vacuum into the welding chamber.

12. A method of electron beam welding vehicle batteries according to claim 9, further comprising conveying the battery array and the bus bar between the chambers using a conveyor means comprising three substantially adjoining sections, one section disposed in each chamber.

13. A method of electron beam welding vehicle batteries according to claim 9, wherein the battery array is an array of cylindrical cells.

14. Electron beam welding apparatus according to claim 1, further comprising conveying means associated with the chambers for transport of a battery array and a bus bar between the chambers.

15. Electron beam welding apparatus according to claim 14, wherein the conveying means comprises a conveyor means comprising three substantially adjoining sections, one section disposed in each chamber.

16. Electron beam welding apparatus according to claim 14, wherein the conveying means comprises a pushing element.

17. Electron beam welding apparatus according to claim 1, further comprising a linear succession of a plurality of subsidiary chambers.
